(19) United States
(12) Patent Application Publication
(10) Pub. No.: US 2017/0027798 A1
(43) Pub. Date: Feb. 2, 2017

(54) APPARATUS, SYSTEM, AND METHOD FOR A RECIPROCATING TREATMENT DEVICE

(71) Applicant: Theragun, LLC, Beverly Hills, CA (US)

(72) Inventor: Jason Wersland, Manhattan Beach, CA (US)

(21) Appl. No.: 15/292,090

(22) Filed: Oct. 12, 2016

Related U.S. Application Data
(63) Continuation of application No. 15/186,859, filed on Jun. 20, 2016.
(60) Provisional application No. 62/182,525, filed on Jun. 20, 2015.

(51) Int. Cl. A61H 1/00

(52) U.S. Cl. CPC A61H 1/00; A61H 2201/1669; A61H 2201/123; A61H 2201/5007

(57) ABSTRACT

A reciprocal treatment device. The reciprocal treatment device includes a battery, a motor, a trigger, an actuated output, and a treatment structure. The trigger is in electrical communication with the battery and the motor. The trigger selectively provides power from the battery to the motor. The actuated output is operatively connected to the motor and configured to reciprocate in response to activation of the motor. The treatment structure is operatively connected to the actuated output.

### CROSS-REFERENCE TO RELATED APPLICATIONS

This application is a continuation of U.S. patent application Ser. No. 15/186,859, entitled “Apparatus, System, and Method for a Reciprocating Therapeutic Device,” which was filed on Jun. 20, 2016, which claims the benefit of U.S. Provisional Patent Application No. 62/182,525, entitled “Apparatus, System, and Method for a Reciprocating Therapeutic Device,” which was filed on Jun. 20, 2015, each of which is hereby incorporated by reference.

### SUMMARY

An embodiment provides a reciprocal treatment device. The reciprocal treatment device includes a battery, a motor, a trigger, an actuated output, and a treatment structure. The trigger is in electrical communication with the battery and the motor. The trigger selectively provides power from the battery to the motor. The actuated output is operatively connected to the motor and configured to reciprocate in response to activation of the motor. The treatment structure is operatively connected to the actuated output. Other embodiments of a reciprocal treatment device are also described.

### BRIEF DESCRIPTION OF THE SEVERAL VIEWS OF THE DRAWINGS

FIG. 1 depicts a side view of one embodiment of a reciprocating treatment device.

FIG. 2 depicts a side view of one embodiment of the reciprocating treatment device of FIG. 1.

FIGS. 3A and 3B depict side views of embodiments of interchangeable attachments for use with the reciprocating treatment device of FIG. 1.

FIGS. 4A-4D depict side views of embodiments of interchangeable attachments for use with the reciprocating treatment device of FIG. 1.

FIG. 5 depicts a side view of one embodiment of a treatment structure of an interchangeable attachment of FIG. 3A.

FIG. 6 depicts a side view of one embodiment of a shank of an interchangeable attachment of FIG. 3A.

FIG. 7 depicts a side view of one embodiment of a shank of an interchangeable attachment of FIG. 3A.

FIGS. 8A-8B depict side views of one embodiment of a shank and a treatment structure of an interchangeable attachment.

FIGS. 9A-9C depict views of another embodiment of a shank and a treatment structure of an interchangeable attachment.

FIG. 10A-10C depict views of another embodiment of a shank and a treatment structure of an interchangeable attachment.

FIGS. 11A-11C depict views of one embodiment of a treatment structure.

FIGS. 12A-12C depict views of another embodiment of a treatment structure.

FIGS. 13A-13B depict views of one embodiment of a shank of an interchangeable attachment.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide an apparatus, system, and method for a reciprocating treatment device.

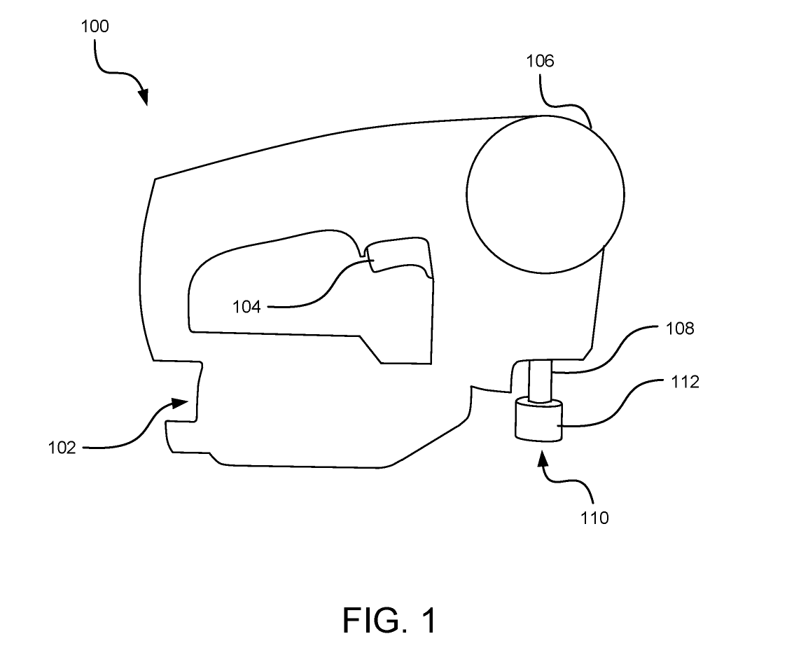

FIG. 1 depicts a side view of one embodiment of a reciprocating treatment device 100. The reciprocating treatment device 100 includes a power input 102, a trigger 104, a motor 106, and an actuated output 108. The reciprocating treatment device 100, in some embodiments, generates motion at the actuated output 108 for treating a patient.

The power input 102, in some embodiments, is configured to receive a power input from a power source (not shown). The power source may be any type of power source capable of supplying power to the motor 106. In one embodiment, the power input 102 receives an electrical input from the power source. For example, the power source may be a battery that provides electrical current. In one embodiment, the battery is a rechargeable battery. In some embodiments, the battery is attachable to the reciprocating treatment device 100 such that the reciprocating treatment device 100 including the power source is portable and cordless. In an alternative embodiment, the reciprocating treatment device 100 uses an external battery pack.

The battery may be any type of battery known in the art. For example, the battery may include a rechargeable lithium-ion (LiIon) based battery. In another example, the battery may include a rechargeable nickel metal hydride (NiMH) battery. In yet another example, the battery may include a rechargeable lithium-polymer (LiPo) battery. In some embodiments, the battery includes a nickel-cadmium (NiCad) battery. In one embodiment, the battery uses a non-rechargeable battery.

In an alternative embodiment, the power input 102 includes a cord to receive power from an electrical grid. For example, the reciprocating treatment device 100 may include a cord with a plug configured to interface with a wall socket to provide power.

In another alternative embodiment, the power input 102 is non-electrical. For example, the power input 102 may receive pressurized air from a pressure vessel or a network of pressurized air. In another embodiment, the power input may include one or more reactive materials to provide energy for operation of the reciprocating treatment device 100.

The trigger 104, in some embodiments, controls delivery of power to the motor 106. The trigger 104 may be an electrical switch configured to allow passage of electric current when activated. In some embodiments, the trigger 104 is a binary on/off switch. In another embodiment, the trigger 104 is a variable trigger. A variable trigger controls the amount of power delivered to the motor 106. A relatively high amount of power delivered to the motor 106 by the variable trigger 104 results in an increased speed of the motor 106. Are relatively low amount of power delivered to the motor 106 by the variable trigger 104 results in a decreased speed of the motor 106. In one embodiment, the variable trigger 104 is a variable resistor that allows a progressively increased amount of power to flow to the motor 106 in response to a progressively increasing activation of that trigger 104.

The motor 106, in one embodiment, converts power from the power source 102 into motion. In some embodiments, the motor 106 is an electric motor. The electric motor may be any type of electric motor known in the art, including, but not limited to, a brushed motor, a brushless motor, a direct current (DC) motor, an alternating current (AC) motor, a mechanical-commutator motor, an electronic commutator motor, or an externally commutated motor.

In some embodiments, the motor 106 operates at a speed that can be varied by different levels of activation of the trigger 104. For example, the motor 106 may operate at a maximum rate in response to a maximum activation of the trigger 104. The motor 106 may operate at a lower rate in response to a less than maximum activation of the trigger 104.

The motor 106 may produce rotary motion. In some embodiments, the reciprocating treatment device 100 may include a linkage (not shown) to convert the rotary motion of the motor 106 into reciprocating motion. For example, the motor 106 may be a brushless DC motor that generates rotary motion, and the linkage may include a crank to convert the rotary motion into linear motion.

In an alternative embodiment, the motor 106 may produce reciprocating motion. For example, the motor 106 may include a reciprocating pneumatic cylinder that reciprocates in response to an input of compressed air.

The actuated output 108, in some embodiments, reciprocates in response to an input from the motor 106. For example, the motor 106 may produce rotary motion. A crank (not shown) may be connected to the motor 106 to convert the rotary motion to reciprocating motion at a connected slider (not shown). The slider may be connected to the actuated output 108.

In some embodiments, the actuated output 108 reciprocates at a rate of approximately 65 Hz. The actuated output 108, in some embodiments, reciprocates at a rate over 50 Hz. The reciprocating treatment device 100, in some embodiments, provides reciprocation at a rate ranging between 50 Hz and 80 Hz. In some embodiments, the actuated output 108 has a maximum articulation rate of between 50 Hz and 80 Hz. In another embodiment, the actuated output 108 has an articulation rate of between 30 Hz and 80 Hz. In certain embodiments, the actuated output 108 has an articulation rate of approximately 37 Hz. In one embodiment, the actuated output 108 has an articulation rate of approximately 60 Hz.

The actuated output 108 may move through a predetermined range of reciprocation. For example, the actuated output 108 may be configured to have an amplitude of one half inch. In another embodiment, the actuated output 108 may be configured to have an amplitude of one quarter inch. As will be appreciated by one skilled in the art, the actuated output 108 may be configured to have any amplitude deemed therapeutically beneficial.

In some embodiments, the actuated output 108 may be adjustable through a variable range of reciprocation. For example, the reciprocating treatment device 100 may include an input to adjust the reciprocation amplitude from one quarter of an inch through a range of up to one inch.

In certain embodiments, the reciprocating treatment device 100 includes one or more components to regulate the articulation rate of the actuated output 108 in response to varying levels of power provided at the power input 102. For example, the reciprocating treatment device 100 may include a voltage regulator (not shown) to provide a substantially constant voltage to the motor 106 over a range of input voltages. In another embodiment, the current provided to the motor 106 may be regulated. In some embodiments, operation of the reciprocating treatment device 100 may be restricted in response to an input voltage being below a preset value.

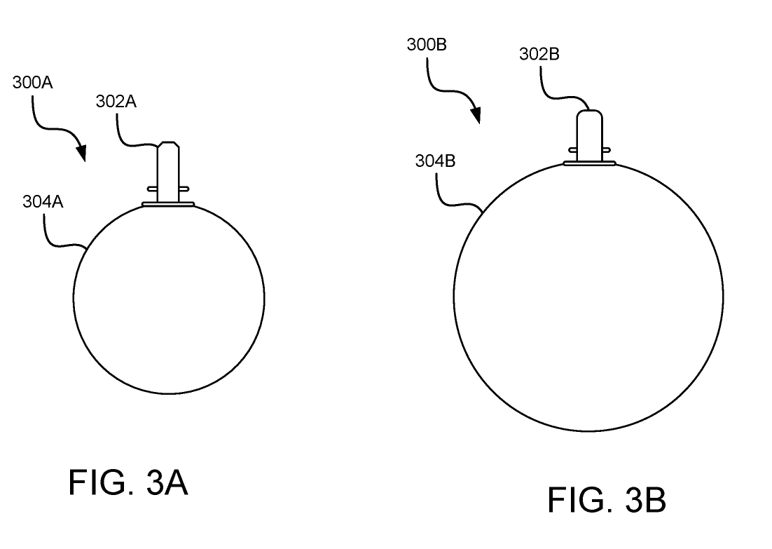

In some embodiments, the actuated output 108 includes a connection socket 110 for connection of an attachment. Several embodiments of attachments are described below in FIGS. 3A-7.

In some embodiments, the actuated output 108 includes a securing mechanism 112 for securing an attachment in the connection socket 110. For example, the securing mechanism 112 may include a biased structure, such as a spring, to bias the securing mechanism 112 toward a locked position. In the locked position, the securing mechanism 112 may restrict removal of an attachment. The biased structure may be articulated by a user to move the securing mechanism 112 toward an unlocked position. In the unlocked position, the securing mechanism may allow removal of an attachment.

In some embodiments, the securing mechanism 112 includes a keyway to interact with a key on an attachment. The keyway may be selectively opened and closed by articulation of the securing mechanism 112. Removal of an attachment may be restricted in response to the keyway being closed.

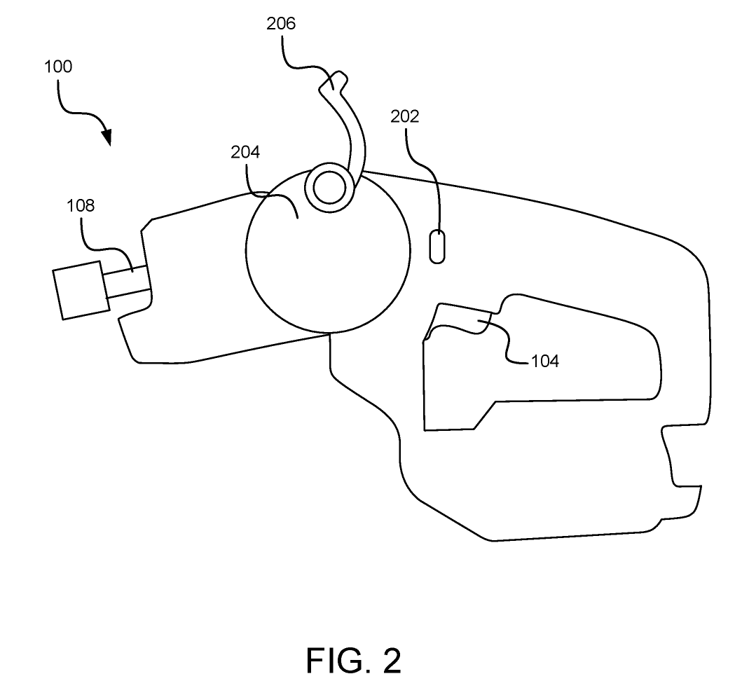

FIG. 2 depicts a side view of one embodiment of the reciprocating treatment device 100 of FIG. 1. The reciprocating treatment device 100 includes the trigger 104, a trigger lock 202, an articulating head 204, an articulation lock 206 and the actuated output 108. The reciprocating treatment device 100 provides reciprocating motion at the actuated output 108.

In some embodiments, the trigger 104 controls delivery of power to other elements of the reciprocating treatment device 100. The trigger lock 202, in one embodiment, restricts activation of the trigger 104. The trigger lock 202 may be biased, such as by a spring, to a position that interferes with motion of the trigger 104. A user may activate the trigger lock 202 such that it does not interfere with motion of the trigger 104 so that the trigger 104 can be activated. For example, the trigger lock 202 may be a button, and the trigger 104 may be locked by the trigger lock 202 such that the reciprocating treatment device 100 cannot be operated unless a user pushes the button to deactivate the trigger lock 202.

In another embodiment, the trigger lock 202 is configured to be actuated to lock the trigger 104 in an activated position. The trigger lock 202 may be biased, such as by a spring, to a position that does not interfere with motion of the trigger 104. A user may activate the trigger lock 202 such that it does interfere with deactivation of the trigger 104 so that the trigger 104 can be locked in an activated position. For example, the trigger lock 202 may be a button, and the trigger 104 may be unlocked by the trigger lock 202 in response to the trigger lock 202 being deactivated by a user. In response to a user activating the trigger lock 202 by pushing the button while the trigger 104 is in an activated position, the trigger 104 may be locked in the activated position. In some embodiments, a user may deactivate the trigger lock 202 by actuating one of the trigger 104 or the trigger lock 202. In some embodiments, the trigger 102 and the trigger lock 202 are discrete components. In another embodiment, the trigger 102 and the trigger lock 202 are integrated into the same component.

The articulating head 204, in some embodiments, allows for rotation of components of the reciprocating treatment device 100 including the actuated output 108. Articulation of the articulating head 204 changes the position of the actuated output 108 relative to other components of the reciprocating treatment device 100, such as the trigger 104. Changing the position of the actuated output 108 relative to the trigger 104 may make operation of the reciprocating treatment device 100 more comfortable, convenient, or effective.

In some embodiments, the articulating head 204 is rotatable around an axis. In certain embodiments, the articulating head 204 is rotatable through a predetermined range of motion. For example, the articulating head 204 may be rotatable through approximately 90 degrees. As will be appreciated by one skilled in the art, the articulating head may have any range of articulation.

The articulating head 204, in some embodiments, is fastenable such that articulation is restricted and unfastenable such that articulation is allowed by the articulation lock 206. The articulation lock 206 may include any locking mechanism known in the art for restricting rotation of a structure. For example, the articulation lock 206 may include a lever that draws two surfaces into interference when activated and moves the two surfaces out of interference when deactivated.

In one embodiment, the articulating head 204 includes a plurality of preset positions in which the articulating head 204 can be locked. For example, the articulating head 204 may have eight substantially evenly spaced preset positions approximately thirteen degrees apart. In another example, the articulating head 204 may have four preset positions at varying spacing. As will be appreciated by one skilled in the art, the articulating head 204 may have any number and locations of preset positions.

FIGS. 3A and 3B depict side views of embodiments of interchangeable attachments 300A, 300B (collectively, “300”) for use with the reciprocating treatment device 100 of FIG. 1. The interchangeable attachments 300 include a shank 302A, 302B (collectively, “302”) and a treatment structure 304A, 304B (collectively, “304”). The interchangeable attachments 300 provide user-selectable types of treatment for varying types of therapy.

The shanks 302 are configured to interface with the connection socket 110 of the reciprocating treatment device 100. In some embodiments, the shanks 302 include a structure for interfacing with the securing mechanism 112 such that the attachments 300 are secureable to the connection socket 110.

The treatment structures 304, in some embodiments, are configured to deliver the motion of the reciprocating treatment device 100 to a patient. In some embodiments, the treatment structures 304 include a compliant material capable of deforming under load. The treatment structures 304 may include a flexible polymer. In one example, the treatment structures 304 include polyurethane foam, thermoplastic elastomer (“TPE”), including but not limited to Styrenic block copolymers (TPE-s), Polyolefin blends (TPE-o), Elastomeric alloys (TPE-v or TPV), Thermoplastic polyurethanes (TPU), Thermoplastic copolyester, or Thermoplastic polyamide. In another example, the treatment structures 304 may include polyvinyl chloride (PVC), low durometer PVC, or a urethane.

In some embodiments, the treatment structures 304 include a shell. The shell may improve durability of the attachments 300 by protecting an interior material of the treatment structures 304 from abrasion or other damage in use. In another embodiment, the shell may be a material configured to increase the comfort of a patient or enhance a therapeutic effect. The shell may include any material, including but not limited to a flexible polymer.

The treatment structure 304 may have varying sizes. For example, treatment structure 304A may be substantially spherical and have a diameter of approximately one inch, and treatment structure 304B may be substantially spherical and have a diameter of approximately two inches. As will be appreciated by one skilled in the art, the treatment structures 304 may have any shape and size. For example, a treatment structure may be a sphere with a diameter of one half an inch. In another example, a treatment structure may be a sphere with a diameter of three inches. In some embodiments, substantially spherical treatment structures ranging from one half inch to three inches may be provided.

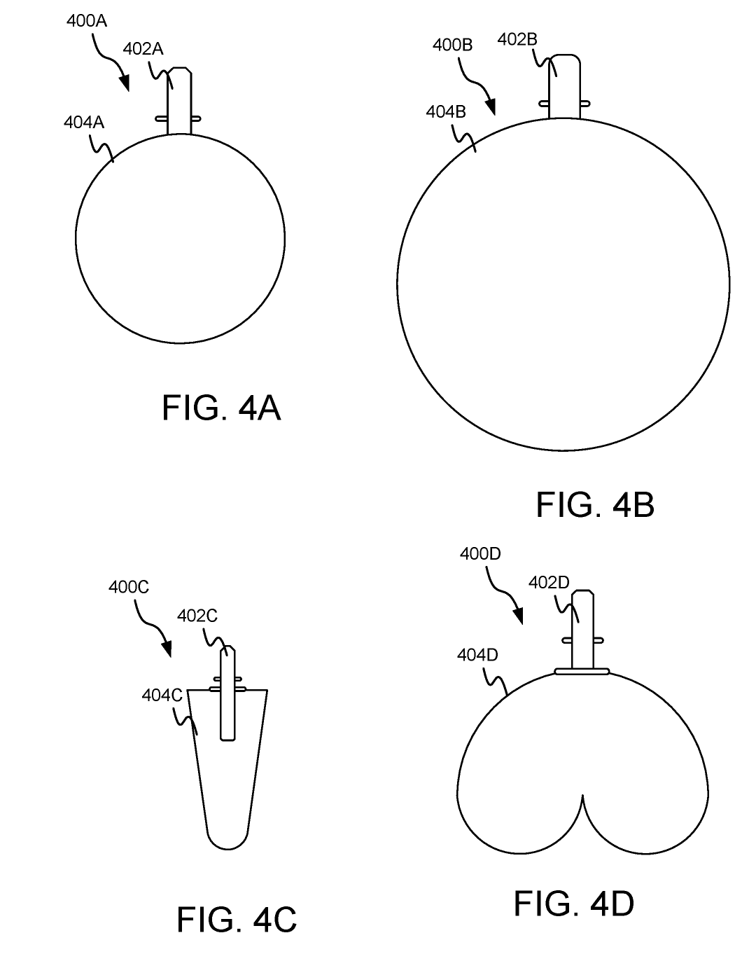

FIGS. 4A-4D depict side views of embodiments of interchangeable attachments 400A-400D (collectively, “400”) for use with the reciprocating treatment device 100 of FIG. 1. The interchangeable attachments 400 include a shank 402A-402D (collectively, “402”) and a treatment structure 404A-404D (collectively, “404”). The interchangeable attachments 400 provide user-selectable types of treatment for varying types of therapy.

The shanks 402 are configured to interface with the connection socket 110 of the reciprocating treatment device 100. In some embodiments, the shanks 402 include a structure for interfacing with the securing mechanism 112 such that the attachments 400 are secureable to the connection socket 110.

The treatment structures 404 provide varying shapes or sizes that provide varying therapeutic effects. For example, treatment structures 404A and 404B may be substantially spherical structures with sizes of one and one half inches and two and one half inches, respectively. Relatively large and small treatment structures 404A, 404B may be appropriate for treating relatively large and small muscles, respectively.

In some embodiments, the treatment structures 404 have non-spherical shapes. For example, in the embodiment illustrated in FIG. 4C, the treatment structure 404C is substantially conic in shape. The treatment structure 404C may include a rounded apex in some embodiments.

In some embodiments, the treatment structures 400 have multiple lobes. For example, in the embodiment illustrated in FIG. 4D, the treatment structure 404D has a profile including two lobes with a valley between the lobes. A two lobed structure may be useful for treating muscles on either side of a bony structure, such as the spine.

As will be appreciated by one skilled in the art, the treatment structure 400 may take any shape, including geometric shapes or shapes that mimic hands or fingers. In addition, a treatment structure 400 may include any material, including compliant materials, semi-rigid materials, and rigid materials.

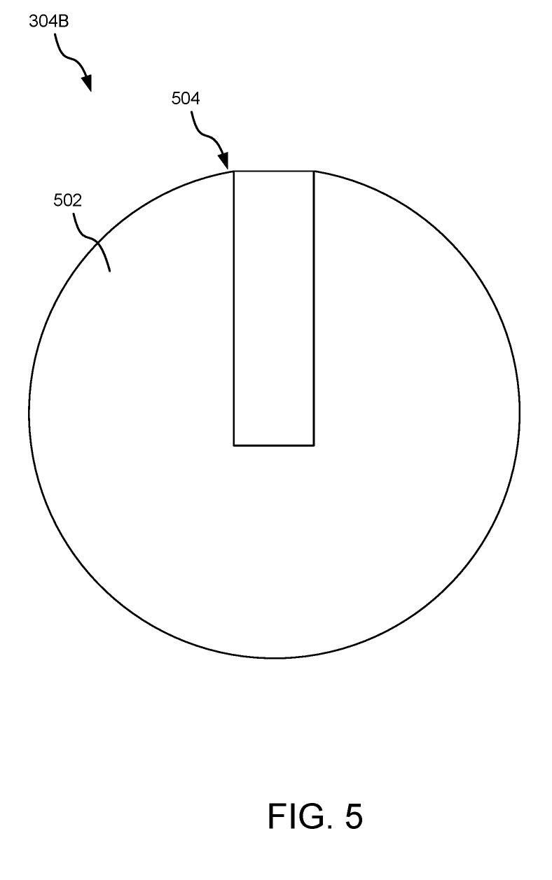

FIG. 5 depicts a side view of one embodiment of a treatment structure 304B of the interchangeable attachment 300B of FIG. 3B. The treatment structure 304B includes a compliant material 502 and a shank interface cavity 504. The treatment structure 304B transfers force provided by the reciprocating treatment device 100 to a patient.

The complaint material 502 may mitigate some shock load provided by the reciprocating treatment device 100. For example, the compliant material 502 may deform in response to extension of the actuated output 108. Deformation of the compliant material 502 may reduce some of the shock load generated by the reciprocating treatment device 100 and have therapeutic benefit. In an alternate embodiment, the treatment structure 304B may include a rigid or semi-rigid material to deliver a more percussive force to a patient.

The shank interface cavity 504, in one embodiment, provides an interface to receive a shank 302B. The shank interface cavity 504, in one embodiment, is sized smaller than the shank 302B so as to provide an interference fit with the shank 304B. In some embodiments, the shank 302B is fastened in the shank interface cavity, such as by an adhesive.

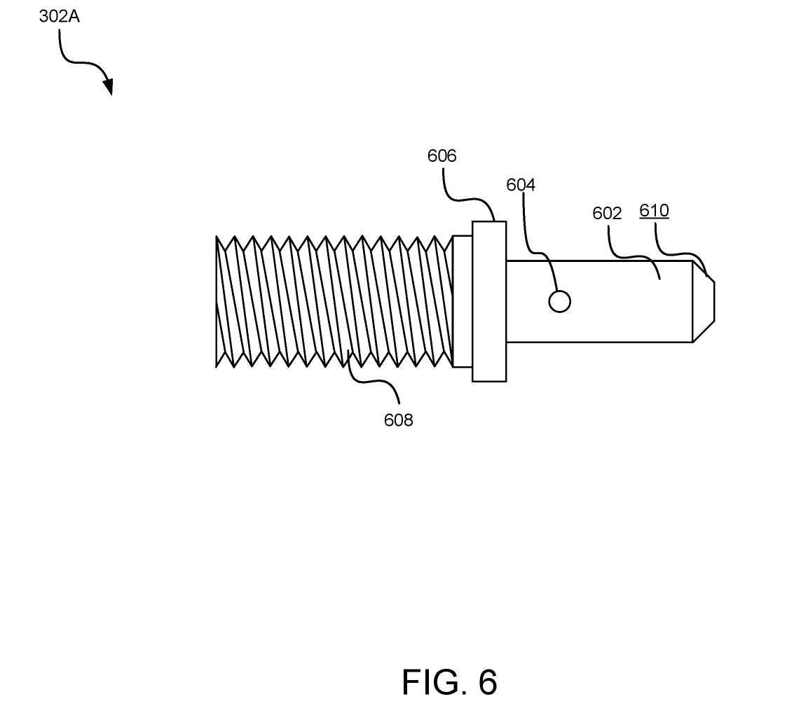

FIG. 6 depicts a side view of one embodiment of a shank 302A of an interchangeable attachment 300A of FIG. 3A. The shank 302A includes an insert 602, a locking structure 604, a shoulder 606, and a treatment structure interface 608. The shank 302A removably connects to the reciprocating treatment device 100 and transfers motion to the treatment structure 304A.

In some embodiments, the insert 602 is configured to be removeably inserted into the connection socket 110 of the reciprocating treatment device 100. The insert 602 may be sized such that it is smaller in cross-section than the connection socket 110. In some embodiments, the insert 602 has a cross-section that corresponds in shape to that of the connection socket 110. For example, the insert 602 and the connection socket 110 may have a circular cross-section. In another example, the insert 602 and the connection socket 110 may have a hexagonal cross-section.

In some embodiments, the insert 602 includes a tapered surface 610. The tapered surface 610 may include a portion that has a cross-sectional profile that is smaller than other areas of the insert 602. The tapered surface 610 may facilitate insertion of the insert 602 into the connection socket 110. In another embodiment, the tapered surface 610 may be selectively engageable by the securing mechanism 112 to secure the shank 302A in the connection socket 110.

In some embodiments, the shank 302A includes a locking structure 604. The locking structure 604 may be selectively engageable by the securing mechanism 112 to secure the shank 302A in the connection socket 110. In one embodiment, the locking structure 604 includes a pin mounted in an aperture formed transversely through the shank 302A. The pin may be configured to slide within an open keyway of the securing mechanism 112. The pin may be configured to restrict movement of the shank 302 relative to the connection socket 110 in response to the securing mechanism 112 being engaged.

The shoulder 606, in some embodiments, restricts the depth to which the shank 302A may be inserted into the connection socket 110. In one embodiment, the shoulder 606 has a cross section that is larger than that of the interior of the connection socket 110.

As will be appreciated by one skilled in the art, the configuration of the shank 302A and the connection socket 110 could be reversed such that a shank was connected to the actuated output 108 and the interchangeable attachment 300A included a socket to fit over and engage with the shank 302A. Such an arrangement is within the scope of this disclosure.

The treatment structure interface 608, in one embodiment, provides an interface for connecting the shank 302A to a treatment structure 304A. In one embodiment, the treatment structure interface 608 includes an uneven surface to facilitate a secure connection to the treatment structure 304A. In some embodiments, the treatment structure interface 608 includes a thread to provide a secure interface and facilitate connection of the treatment structure interface 608 to the treatment structure 304A. In another embodiment, the treatment structure interface 308 is substantially smooth.

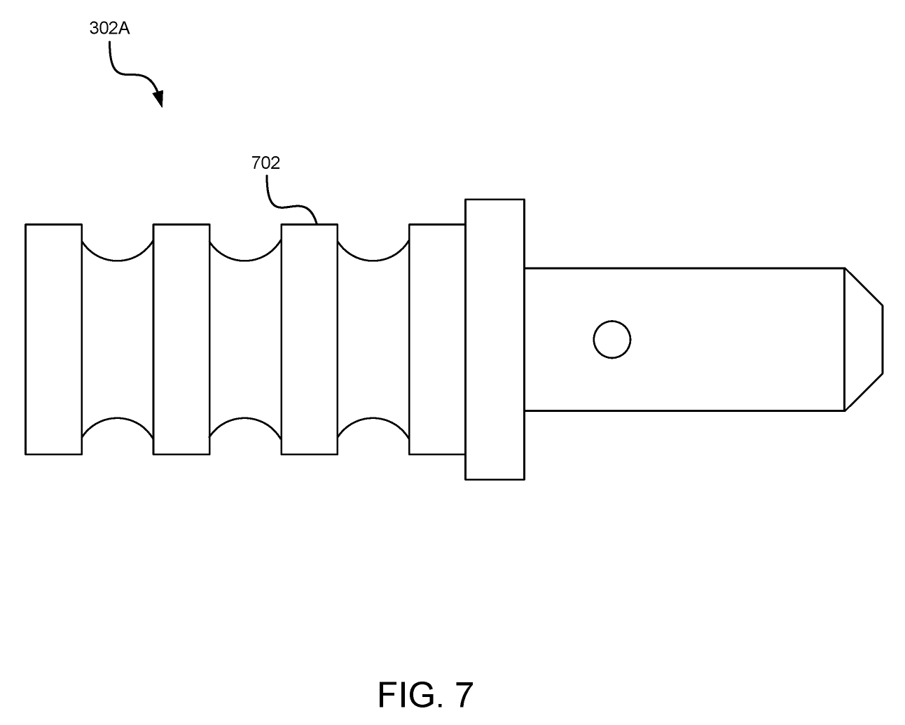

FIG. 7 depicts a side view of one embodiment of a shank 302A of an interchangeable attachment 300A of FIG. 3A. The shank 302A includes a treatment structure interface 702. The shank 302A removably connects to the reciprocating treatment device 100 and transfers motion to the treatment structure 304A.

The treatment structure interface 702, in one embodiment, provides an interface for connecting the shank 302A to the treatment structure 304A. The treatment structure interface 702 may include a changing cross sectional profile along the longitudinal axis of the shank 302A. In one embodiment, the treatment structure interface 702 has areas of relatively large cross-sectional area and areas of relatively small cross-sectional area. The changes in cross-sectional area in the treatment structure interface 702 may result in a relatively secure connection between the shank 302A and the treatment structure 304A.

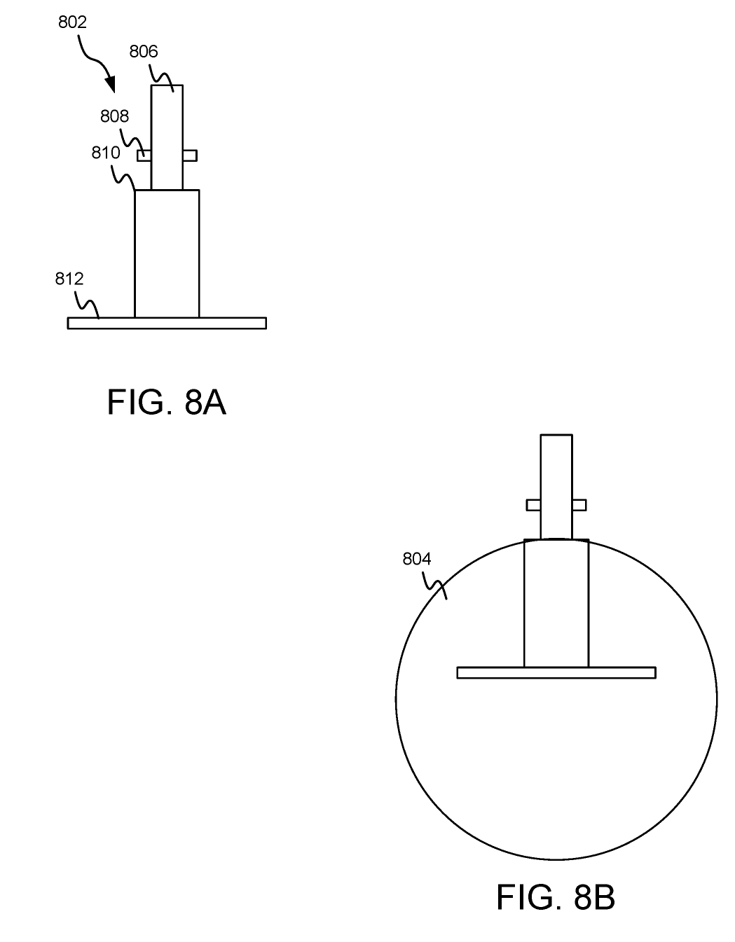

FIGS. 8A-8B depict side views of one embodiment of a shank 802 and a treatment structure 804 of an interchangeable attachment. The shank 802 includes an insert 806, a locking structure 808, a shoulder 810, and a base 812. The shank 802 removably connects to the reciprocating treatment device 100 and transfers motion to the treatment structure 804.

In some embodiments, the treatment structure 804, the insert 806, the locking structure 808, and the shoulder 810 are similar to like-named structures described above. The base 812, in some embodiments, includes a flange oriented substantially perpendicular to the axis of the insert 806. In certain embodiments, the flange traverses a significant portion of the treatment structure 804. For example, the flange may be substantially circular in cross-section and have a diameter of one inch. The flange may interface with a spherical treatment structure 804 having a diameter of one and a half inches.

In some embodiments, the flange may have a cross-sectional area equal to approximately one half the maximum cross-sectional area of the treatment structure 804. In another embodiment, the flange may have a cross-sectional area equal to approximately two thirds the maximum cross-sectional area of the treatment structure 804. In certain embodiments, the flange may have a cross-sectional area equal to between one quarter and three quarters of the maximum cross-sectional area of the treatment structure 804.

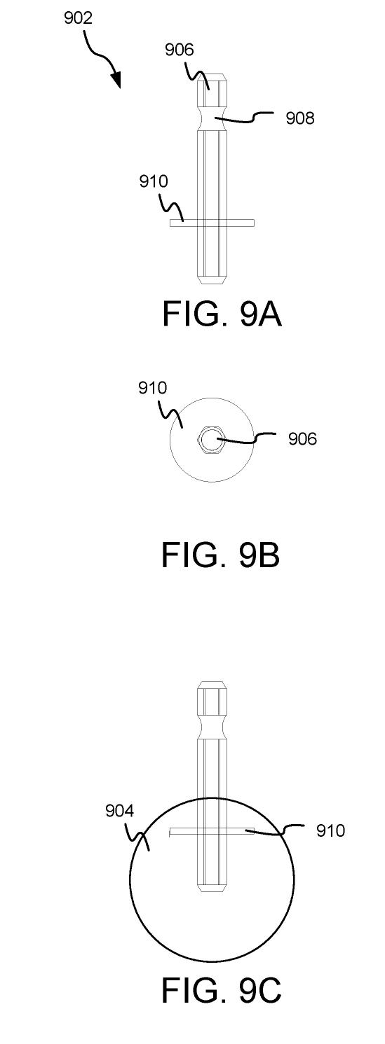

FIGS. 9A-9C depict views of another embodiment of a shank 902 and a treatment structure 904 of an interchangeable attachment. The shank 902 includes an insert 906, a locking structure 908, and a base 910. The shank 902 removably connects to the reciprocating treatment device 100 and transfers motion to the treatment structure 904. In some embodiments, the treatment structure 904 and the base 910 are similar to like-named structures described above.

The insert 906, in some embodiments, has a non-circular cross-sectional shape. In one embodiment, the insert 906 has a hexagonal cross-sectional shape. The cross-sectional shape of the insert may correspond to a cross-sectional shape of the connection socket 110.

The locking structure 908, in one embodiment, includes a recessed structure disposed on the insert 906. The recessed structure may interface with a corresponding structure of the connection socket to selectively secure the shank 902 to the connection socket 110. For example, the connection socket 110 may include a spring-biased structure that interfaces with the recessed structure and restricts removal of the shank 906.

In the illustrated embodiment, the treatment structure 904 is a spherical shape, though any shape of treatment structure may be employed.

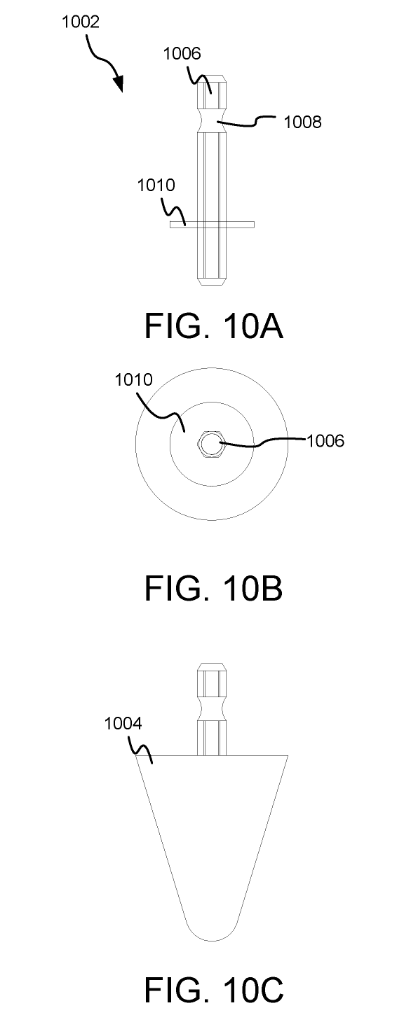

FIG. 10A-10C depict views of another embodiment of a shank 1002 and a treatment structure 1004 of an interchangeable attachment. The shank 1002 includes an insert 1006, a locking structure 1008, and a base 1010. The shank 1002 removably connects to the reciprocating treatment device 100 and transfers motion to the treatment structure 1004. In some embodiments, the insert 1006, the locking mechanism 1008, and the base 1010 are similar to like-named structures described above. In the illustrated embodiment, the treatment structure 1004 is substantially cone-shaped.

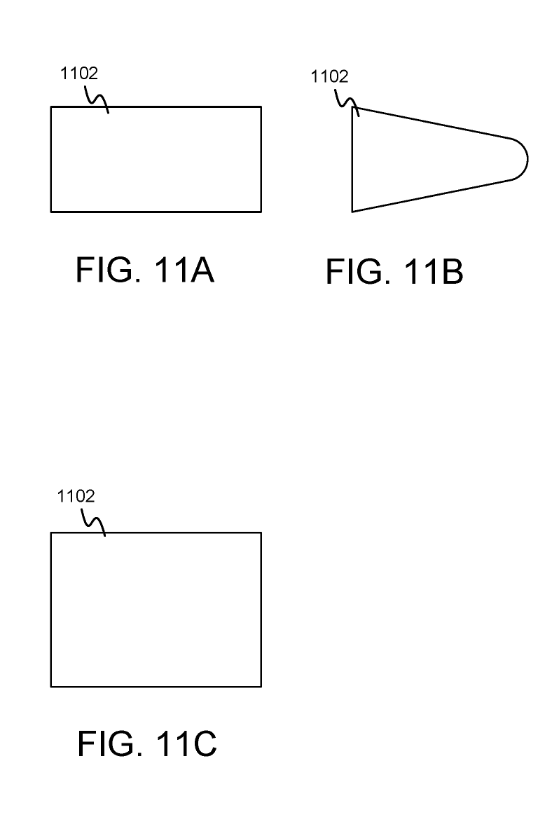

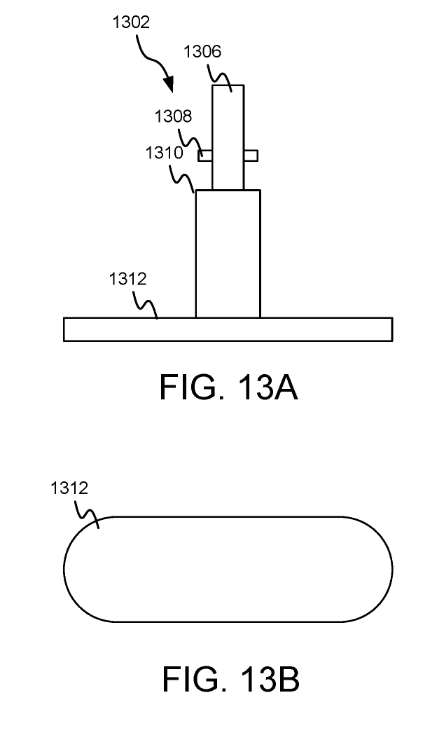

FIGS. 11A-11C depict views of one embodiment of a treatment structure 1102. The figures show atop, side, and front view respectively. The illustrated treatment structure 1102 has a substantially wedge shape, having a substantially constant width and a substantially decreasing depth across a plane moving away from the treatment device 100. In some embodiments, the treatment structure 1102 includes a rounded end 1104 disposed at the most distal portion of the treatment structure 1102 from a shank attached to the treatment structure 1102. An example of a shank that may be used with the illustrated treatment device is described below in relation to FIGS. 13A-B.

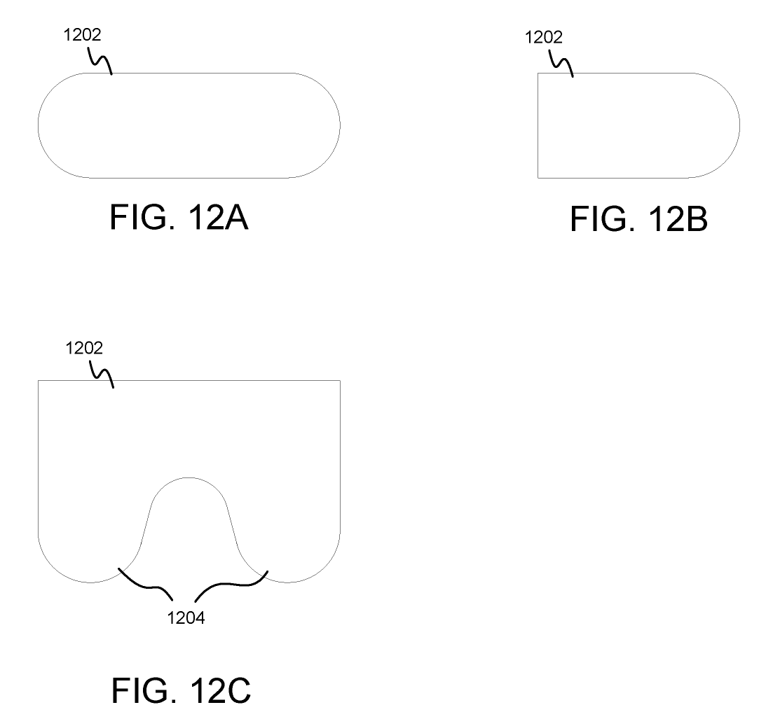

FIGS. 12A-12C depict views of another embodiment of a treatment structure 1202. The figures show a top, side, and front view respectively. The illustrated treatment structure 1202 has a plurality of lobes 1204. The lobes 1204 may have a substantially hemispherical distal surface. An example of a shank that may be used with the illustrated treatment device is described below in relation to FIGS. 13A-B.

FIGS. 13A-13B depict views of one embodiment of a shank 1302 of an interchangeable attachment. The shank 1302 includes an insert 1306, a locking structure 1308, a shoulder 1310, and abase 1312. The shank 1302 removably connects to the reciprocating treatment device 100 and transfers motion to a treatment structure.

In some embodiments, the insert 1306, the locking structure 1308, and the shoulder 1310 are similar to like-named structures described above. The base 1312, in some embodiments, includes a flange oriented substantially perpendicular to the axis of the insert 1306. In certain embodiments, the flange has an elongated cross-sectional shape. The elongated cross-sectional shape of the base 1312 may provide a relatively effective interface with a treatment structure having an elongated cross-sectional shape.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A removeable attachment for a reciprocal treatment device comprising:
a shank removeably connectable to the reciprocal treatment device;
wherein the shank comprises a structure for selectively interfacing with a securing mechanism of the reciprocal treatment device; and
a treatment structure connected to the shank.

2. The removeable attachment of claim 1, wherein the structure for selectively interfacing with a securing mechanism of the reciprocal treatment device comprises a locking structure that is selectively engageable by the securing mechanism.

3. The removeable attachment of claim 2, wherein the locking structure comprises a projection disposed on the shank.

4. The removeable attachment of claim 3, wherein the securing mechanism comprises a keyway corresponding to the projection.

5. The removeable attachment of claim 2, wherein the locking structure comprises a recessed structure disposed on the shank.

6. The removeable attachment of claim 2, wherein the locking structure is configured to interface with a securing mechanism that comprises a biased structure articulable from a locked position to an unlocked position, wherein the securing mechanism restricts removal of the removeable attachment in response to the biased structure being in the locked position.

7. The removeable attachment of claim 1, further comprising a shoulder having a cross-sectional area larger than that of a connection socket of the securing mechanism.

8. The removeable attachment of claim 1, further comprising a flange oriented substantially perpendicular to the axis of the shank.

9. The removeable attachment of claim 8, wherein the flange has a cross-sectional area equal to between one quarter and three quarters of the cross sectional area of the treatment structure.

10. The removeable attachment of claim 8, wherein the flange has an elongated cross-sectional shape.

11. The removeable attachment of claim 1, wherein the structure for selectively interfacing with a securing mechanism of the reciprocal treatment device comprises a surface of the shank comprising a circular cross-sectional area.

12. The removeable attachment of claim 11, wherein the circular cross-sectional area has a constant radius throughout the structure for selectively interfacing with a securing mechanism of the reciprocal treatment device.

13. A reciprocal treatment device comprising:
an electrical input;
a motor;
a trigger in electrical communication with the electrical input and the motor, the trigger configured to selectively provide power from the electrical input to the motor;
an actuated output operatively connected to the motor configured to reciprocate in response to activation of the motor;
a removeable attachment comprising:
a shank removeably connectable to actuated output;
wherein the shank comprises a structure for selectively interfacing with a securing mechanism of the reciprocal treatment device; and
a treatment structure connected to the shank.

14. The reciprocal treatment device of claim 13, wherein the actuated output is connected to the motor through a linkage.

15. The reciprocal treatment device of claim 14 wherein the linkage is a slider crank linkage.

16. The reciprocal treatment device of claim 15 wherein the slider crank linkage causes the actuated output to extend and retract.

17. A method for manufacturing a reciprocal treatment device comprising:
connecting a trigger in electrical communication with a motor and an electrical input;
configuring the trigger to selectively provide power from the electrical input to the motor;
connecting an actuated output to the motor through a linkage, wherein the linkage operates in response to activation of the motor and operation of the linkage causes the actuated output to extend and retract;
assembling a securing mechanism with a biased structure articulable from a locked position to an unlocked position, wherein the securing mechanism restricts removal of a removeable attachment in response to the biased structure being in the locked position;
connecting the securing mechanism to the actuated output; and
assembling a removeable attachment comprising:
forming a treatment structure connectable to a shank; and
forming a locking structure disposed on the shank that is selectively engageable with the securing mechanism.

18. A method for using a reciprocal treatment device comprising:
applying a treatment structure disposed on a removable attachment to a body part, the removable attachment in operable communication with the reciprocal treatment device; and
activating a trigger disposed on the reciprocal treatment device.

19. The method of claim 18, further comprising attaching the removable attachment to a securing mechanism of the reciprocal treatment device.

20. The method of claim 19, further comprising securing the removable attachment to the securing mechanism.
